(19) United States
(12) Patent Application Publication
(10) Pub. No.: US 2024/0296393 A1
(43) Pub. Date: Sep. 5, 2024

(54) OPTIMIZATION PROPOSAL SYSTEM, OPTIMIZATION PROPOSAL METHOD, AND RECORDING MEDIUM

(71) Applicant: NEC Corporation, Minato-ku, Tokyo (JP)

(72) Inventors: Yoji MORI, Tokyo (JP); Toshio Koide, Tokyo (JP); Wataru ITONACA, Tokyo (JP)

(73) Assignee: NEC Corporation, Minato-ku, Tokyo (JP)

(21) Appl. No.: 18/572,854

(22) PCT Filed: Jun. 25, 2021
(86) PCT No.: PCT/JP2021/024163

§ 371 Date: Dec. 21, 2023

(51) Int. Cl. G06Q 10/06; G06Q 10/04

(52) U.S. Cl. CPC G06Q 10/06; G06Q 10/04

(57) ABSTRACT

An optimization proposal device disclosed herein comprises: an optimization target receiving means for receiving an input of an optimization target for achieving a target performance indicator of a city; a personal data receiving means for receiving input of personal data about a plurality of individuals belonging to the city; a personal data analysis means for analyzing requests from the plurality of individuals, on the basis of the received personal data; an individual classification means for classifying individuals on the basis of the analyzed requests; an individual proposal action specifying means for specifying a proposed action for each individual, on the basis of the classification; and an output means for outputting the specified proposed action for each individual.

### TECHNICAL FIELD

The present disclosure relates to an optimization proposal system, an optimization proposal method, and a recording medium.

### BACKGROUND ART

To enable a smart city, there is a technique of prompting an action to deal with individual problems of residents and companies in the city.

For example, PTL 1 discloses a technique for supporting a sojourner who is engaged in work while staying in a predetermined area to engage in work while staying in an area other than the area, from the viewpoint of “well-being”.

### CITATION LIST

### Patent Literature

PTL 1: WO 2020/218500 A

### SUMMARY OF INVENTION

### Technical Problem

However, the invention described in PTL 1 is merely a technique for supporting an individual who is a sojourner engaged in work. To enable a smart city, it is necessary to prompt residents and companies in the city to actively solve a problem of the city, and to solve not only problems of individuals but also the problem of the city.

An example of an object of the present disclosure is to provide an apparatus capable of solving not only problems of individuals but also a problem of a city.

### Solution to Problem

An optimization proposal apparatus according to an aspect of the present disclosure includes an optimization target receiving means that receives an input of an optimization target for achieving a target performance indicator of a city, a personal data receiving means that receives an input of personal data regarding a plurality of individuals belonging to the city, a personal data analysis means that analyzes requests from the plurality of individuals based on the personal data received by the personal data receiving means, an individual classification means that classifies the individuals based on the requests analyzed by the personal data analysis means, an individual proposed action specifying means that specifies a proposed action for each of the individuals based on the classification by the individual classification means, and an output means that outputs the specified proposed action for each of the individuals.

An optimization proposal method according to an aspect of the present disclosure includes receiving an input of an optimization target for achieving a target performance indicator of a city, receiving an input of personal data regarding a plurality of individuals belonging to the city, analyzing requests from the plurality of individuals based on the received personal data, classifying the individuals based on the analyzed requests, specifying a proposed action for each of the individuals based on the classification, and outputting the specified proposed action for each of the individuals.

A recording medium according to an aspect of the present disclosure stores a program for causing a computer to execute receiving an input of an optimization target for achieving a target performance indicator of a city, receiving an input of personal data regarding a plurality of individuals belonging to the city, analyzing requests from the plurality of individuals based on the received personal data, classifying the individuals based on the analyzed requests, specifying a proposed action for each of the individuals based on the classification, and outputting the specified proposed action for each of the individuals.

### Advantageous Effects of Invention

An example of an effect of the present disclosure is to provide an apparatus capable of solving not only problems of individuals but also a problem of a city.

### BRIEF DESCRIPTION OF DRAWINGS

FIG. 1 is a block diagram illustrating a configuration of an optimization proposal apparatus according to a first example embodiment.

FIG. 2 is a diagram illustrating a hardware configuration in which the optimization proposal apparatus according to the first example embodiment is implemented by a computer device and its peripheral device.

FIG. 3 is a flowchart illustrating an operation of the optimization proposal apparatus according to the first example embodiment.

FIG. 4 is a block diagram illustrating a configuration of an optimization proposal apparatus according to a second example embodiment.

FIG. 5 is a flowchart illustrating an operation of optimization proposal in the second example embodiment.

FIG. 6 is a block diagram illustrating a configuration of an outsourced party selecting unit according to a modification of the second example embodiment.

FIG. 7 is a flowchart illustrating an operation of selecting an outsourced party according to the modification of the second example embodiment.

### EXAMPLE EMBODIMENTS

Next, example embodiments will be described in detail with reference to the drawings.

### First Example Embodiment

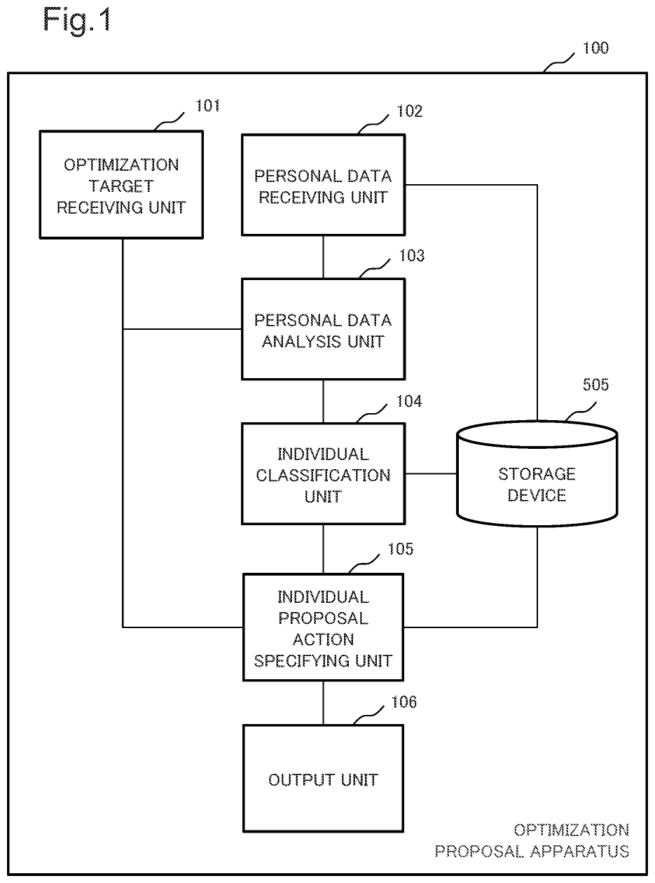

FIG. 1 is a block diagram illustrating a configuration of an optimization proposal apparatus 100 according to a first example embodiment. The optimization proposal apparatus 100 according to the first example embodiment is a system that outputs an action to improve both a problem of an individual and a city indicator. Referring to FIG. 1, the optimization proposal apparatus 100 includes an optimization target receiving unit 101, a personal data receiving unit 102, a personal data analysis unit 103, an individual classification unit 104, an individual proposed action specifying unit 105, and an output unit 106. The optimization proposal apparatus 100 which is an essential configuration of the present example embodiment will be described in detail.

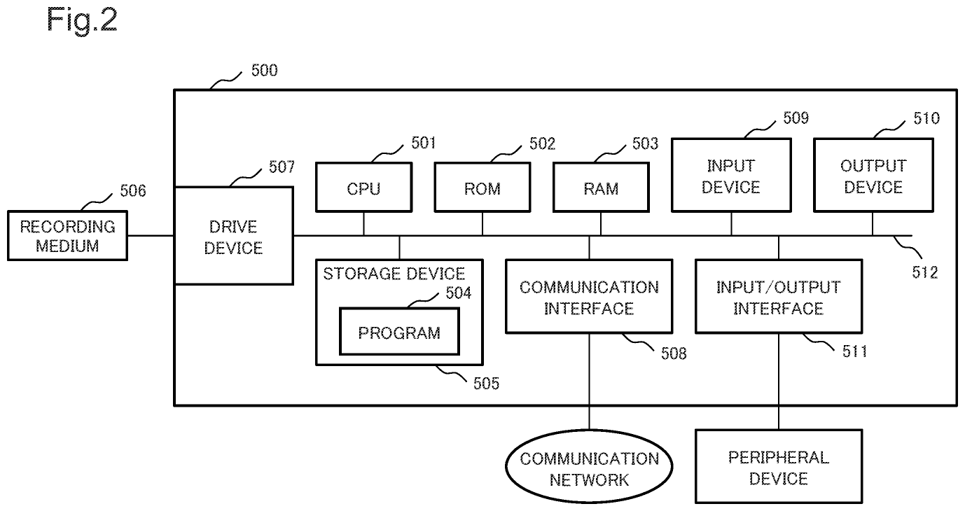

FIG. 2 is a diagram illustrating an exemplary hardware configuration in which the optimization proposal apparatus 100 according to the first example embodiment of the present disclosure is implemented by a computer device 500 including a processor. As illustrated in FIG. 2, the optimization proposal apparatus 100 includes a central processing unit (CPU) 501, memories such as a read only memory (ROM) 502 and a random access memory (RAM) 503, a storage device 505 that stores a program 504 and is a hard disk or the like, a communication interface (I/F) 508 for network connection, and an input/output interface 511 that inputs and outputs data.

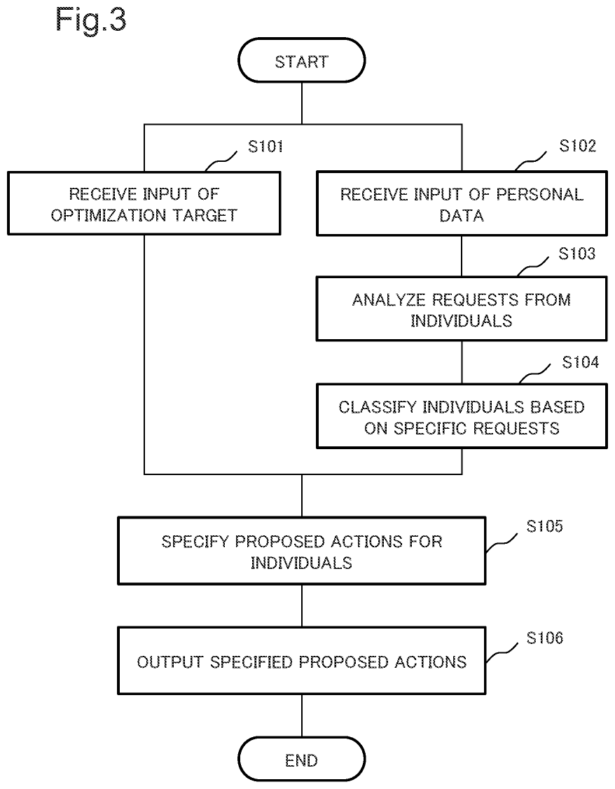

The CPU 501 operates an operating system to control the entire optimization proposal apparatus 100 according to the first example embodiment of the present invention. The CPU 501 reads a program and data from a recording medium 506 mounted on, for example, a drive device 507 to a memory. The CPU 501 functions as the optimization target receiving unit 101, the personal data receiving unit 102, the personal data analysis unit 103, the individual classification unit 104, the individual proposed action specifying unit 105, the output unit 106, and a part thereof in the first example embodiment, and executes processing or a command in a flowchart illustrated in FIG. 3 to be described later based on the program.

The recording medium 506 is, for example, an optical disc, a flexible disk, a magnetic optical disc, an external hard disk, a semiconductor memory, or the like. The recording medium that is a part of the storage device is a nonvolatile storage device, and records the program therein. The program may be downloaded from an external computer (not illustrated) connected to a communication network.

An input device 509 is implemented by, for example, a mouse, a keyboard, a built-in key button, and the like, and is used for an input operation. The input device 509 is not limited to the mouse, the keyboard, and the built-in key button, and may be, for example, a touch panel. An output device 510 is implemented by, for example, a display, and is used to check an output. In the first example embodiment, information received by the optimization target receiving unit 101 and the personal data receiving unit 102 is input to the optimization proposal apparatus 100 via the input device 509, for example.

As described above, the first example embodiment illustrated in FIG. 1 is implemented by the computer hardware illustrated in FIG. 2. However, means for implementing each unit included in the optimization proposal apparatus 100 in FIG. 1 are not limited to the configuration described above. The optimization proposal apparatus 100 may be implemented by one physically coupled device, or may be implemented by a plurality of devices that are two or more physically separated devices connected in a wired or wireless manner. For example, the input device 509 and the output device 510 may be connected to the computer device 500 via a network. The optimization proposal apparatus 100 according to the first example embodiment illustrated in FIG. 1 can also be configured by cloud computing or the like.

In FIG. 1, the optimization target receiving unit 101 is a unit that receives an optimization target for achieving a target performance indicator of a city. The city in the present example embodiment refers to, for example, an area controlled by a specific administrative agency or the administrative agency, and includes not only an area where population is concentrated but also a local area. The target performance indicator of the city is an indicator for quantitatively grasping performance (degree of achievement) of a business corresponding to an administrative problem set by each city. Examples of the administrative problem include promotion of health of residents, economic promotion and environmental problems of the city, and the like. For example, in a case where the administrative problem is promotion of health of residents, a performance indicator such as a 10% reduction in nursing care insurance premiums and a 20% reduction in medical expenses is set.

The optimization target is a specific measure for achieving the performance indicator, and is information that can be input to a trained artificial intelligence (AI) model to analyze a proposed action for implementing the measure. In the case of promoting health of residents as described above, examples of the optimization target include contents such as promoting the residents to walk a specific distance or improving a numerical value of a specific item of a medical examination result. The optimization target receiving unit 101 receives an input of the optimization target through the input device 509 or the like when the optimization proposal apparatus 100 analyzes the proposed action. Upon receiving an input of information regarding the optimization target from an operator, the optimization target receiving unit 101 outputs the received information regarding the optimization target to the personal data analysis unit 103 and the individual proposed action specifying unit 105.

The personal data receiving unit 102 is a unit that receives an input of personal data of individuals belonging to a city. The individuals belonging to the city include not only residents in the city but also people who go to work or school in the city and corporate bodies such as business operators. The personal data is information regarding the specific individuals, and includes, for example, attribute information, health information, degrees of happiness (degrees of well-being), and behavior history information of the individuals, or personal information collected from a sensor.

The personal data receiving unit 102 acquires questionnaires, health examination results, or sensing data of the individuals, converts the data into personal data such as attribute information, health information, degrees of well-being, behavior histories, situations, or states, and stores the personal data to the storage device 505. The attribute information is, for example, age or gender. The health information is, for example, information indicating physiques such as heights and weights or information of results of a health examination. The degrees of well-being are, for example, information from which a demand for life of the individuals can be extracted based on questionnaire results or the like. The situations are, for example, information that allows grasping of personal recent conditions obtained from the contents of a notification to an administrative agency. The states are information obtained from sensing data or behavior history data. These pieces of information are acquired at predetermined time intervals (for example, every few minutes) through a network from mobile terminals possessed by the individuals, a sensor provided in a town, or a camera, and are stored in the storage device 505. For other information, the personal data receiving unit 102 may receive an input of personal data through the input device 509 by a user operation. The personal data receiving unit 102 may periodically acquire the personal data from a personal data store (PDS) or the like that centrally manages the personal data.

The personal data analysis unit 103 is a unit that analyzes requests from the individuals based on the personal data stored in the storage device 505 by the personal data receiving unit 102. When information regarding the optimization target is input from the optimization target receiving unit 101, the personal data analysis unit 103 first analyzes the requests from the individuals. The requests are, for example, related to life of the individuals, such as wanting to live a healthy life or getting a job. A specific request is somewhat related to the optimization target received by the optimization target receiving unit 101. Being related to the optimization target indicates that, for example, when the optimization target is to promote the health of the residents, the requests from the individuals are to live a healthy life. However, the requests are not requests that can be directly grasped from results of a questionnaire, but include requests that can be estimated from the personal data. Upon analyzing the request held by each individual, the personal data analysis unit 103 outputs results of the analysis to the individual classification unit 104.

The individual classification unit 104 is a means for classifying the individuals based on the requests analyzed by the personal data analysis unit 103. The individual classification unit 104 classifies individuals having the specific request based on the personal data. In the first example embodiment, a table in which a name of a classification and a criterion for sorting into the classification are associated with each other is stored in advance in the storage device 505, and the individual classification unit 104 classifies the individuals according to the classification criterion stored in the storage device 505. Examples of the method of classifying the individuals include a method of classifying the individuals according to attributes or personalities of the individuals. The attributes are, for example, age or gender. The personalities are classified, for example, according to behavior histories, an individual with a large amount of action is classified as sociable, and conversely, a person with a small amount of action is classified as introverted. The individual classification unit 104 can also classify the individuals by detailed personality, such as a stubborn person, effect-oriented, skeptic, superior student, companion, or anxious mind, based on answer contents of a questionnaire. It is also possible to classify the individuals according to a walking distance per day necessary for each individual according to results of a medical examination. The individual classification unit 104 outputs classification information classified for each individual to the individual proposed action specifying unit 105.

The individual proposed action specifying unit 105 is a unit that specifies the contents of proposed actions for the individuals for each classification classified by the individual classification unit 104. In the first example embodiment, a table in which the names of the classifications and the contents of the proposed actions for the classifications are associated with each other in advance is stored in the storage device 505. The individual proposed action specifying unit 105 refers to the storage device 505, and specifies the contents of the proposed actions for the individuals according to the classification information input from the individual classification unit 104. The individual proposed action specifying unit 105 outputs the contents of the specified proposed actions for the individuals to the output unit 106. The proposed actions are actions recommended for each of the individuals to satisfy the requests. As the proposed actions, for example, in a case where the classification by the individual classification unit 104 is a daily walking distance necessary for each individual, a restaurant at a distance suitable for each individual and a specific menu are recommended, or a coupon of the menu is provided.

The output unit 106 is a unit that outputs a proposed action specified by the individual proposed action specifying unit 105 such that the operator can browse the proposed action, or notifies a target individual of the proposed action using an application or a mail.

The operation of the optimization proposal apparatus 100 configured as described above will be described with reference to a flowchart of FIG. 3.

FIG. 3 is a flowchart illustrating the operation of the optimization proposal apparatus 100 according to the first example embodiment. A process according to this flowchart may be executed based on program control by the processor described above.

As illustrated in FIG. 3, first, the optimization target receiving unit 101 receives an input of the optimization target (step S101). Next, the personal data receiving unit 102 receives an input of the personal data regarding the individuals (step S102). Next, the personal data analysis unit 103 analyzes requests from the individuals based on the personal data (step S103). The individual classification unit 104 classifies the individuals based on the requests analyzed by the personal data analysis unit 103 (step S104). The individual proposed action specifying unit 105 specifies the contents of the proposed actions for the individuals in order to achieve the optimization target based on the optimization target and the requests for each classification (step S105). Finally, the specified contents of the proposed actions for the individuals are output (step S106). Thus, the optimization proposal apparatus 100 ends the operation of the optimization proposal.

In the optimization proposal apparatus 100, the individual proposed action specifying unit 105 specifies the contents of the proposed actions that improve the optimization target while satisfying the requests from the individuals who have the requests related to the optimization target according to the classifications classified by the individual classification unit 104. As a result, by making different proposed actions for each classification, it is possible to propose an action that each individual can easily take. Since the optimization proposal apparatus 100 can specify a proposed action that leads to a request of an individual and improvement of an optimization target, not only problems of the individuals but also a problem of the city can be solved.

### Modification of First Example Embodiment

In a modification of the first example embodiment, the individual classification unit 104 and the individual proposed action specifying unit 105 specify classifications and the contents of proposed actions for the individuals using trained models. These trained models are also stored in the storage device 505. The individual classification unit 104 and the individual proposed action specifying unit 105 specify the classifications and the contents of the proposed actions for the individuals by using the trained models instead of or in addition to using the table stored in the storage device 505.

In the modification of the first example embodiment, the individual classification unit 104 classifies the individuals by inputting the personal data to a trained model. This model is a model generated by learning the personal data regarding the individuals and the classifications classified based on the personal data as learning data. Examples of the method of classifying the individuals include classification according to the attributes (age, gender), classification according to ingestible food according to results of a medical examination, and classification according to required amounts of exercise according to exercise histories such as walking amounts.

In the modification of the first example embodiment, the individual proposed action specifying unit 105 specifies proposed actions for the individuals by inputting the classifications into a trained model. In this model, in a learning process, a trained model indicating a relationship between one or more combinations of the classifications acquired as the learning data and the optimization target and an action (achieving a request and the optimization target) indicating a correct answer label of the learning data is generated for each combination by using a neural network, graph AI, or another machine learning algorithm. In the learning, the model may be updated and enhanced by verifying the trained model based on rates at which the individuals accept the proposed actions when the proposed actions are actually presented to the individuals.

Next, when information of the optimization target is input from the optimization target receiving unit 101 and the classification information is input from the individual classification unit 104, the individual proposed action specifying unit 105 specifies the contents of proposed actions satisfying the requests and the optimization target by using a trained model corresponding to a combination of the classifications and the optimization target. As described above, the model is trained using the learning data, and the contents of the proposed actions are specified. The model is, for example, a model in which, for example, in a case where an individual's request is a healthy life, when an ingestible food (for example, the amount of salt per day, and the like) is input as classification information, a recommendation list of a menu is output. Another example of the model is a model in which, when an amount of exercise required for the model, position information of an individual, or position information of a restaurant is input, a recommendation list of each restaurant is output. As another example of the model, when a menu in a restaurant is input, a menu recommended from the menu is output. In this model, even for one restaurant, menus in a plurality of restaurants may be input.

In the modification of the first example embodiment, the individual classification unit 104 and the individual proposed action specifying unit 105 specify classifications and the contents of proposed actions for the individuals using the trained models. As a result, it is possible to specify proposed actions according to the reality based on the personal data.

### Second Example Embodiment

Next, a second example embodiment of the present disclosure will be described in detail with reference to the drawings. Hereinafter, description of contents overlapping with the above description will be omitted to the extent that the description of the present example embodiment is not unclear. A function of each component in each example embodiment of an optimization proposal apparatus 110 in the second example embodiment can be implemented not only by hardware but also by a computer device based on program control and firmware, similarly to the computer device illustrated in FIG. 2.

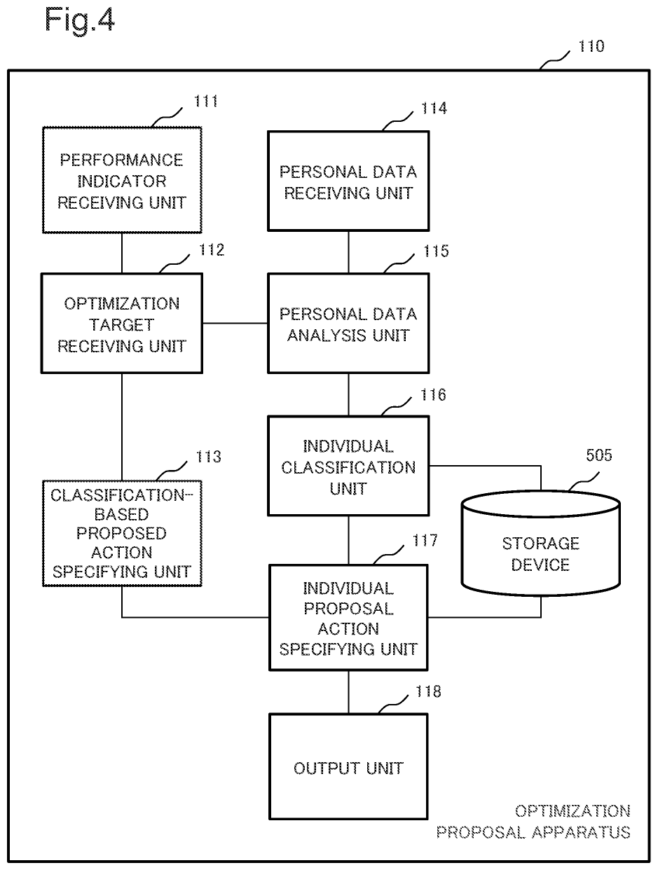

FIG. 4 is a block diagram illustrating a configuration of the optimization proposal apparatus 110 according to the second example embodiment. With reference to FIG. 4, the optimization proposal apparatus 110 according to the second example embodiment will be described focusing on portions different from the optimization proposal apparatus 100 according to the first example embodiment. The optimization proposal apparatus 110 according to the second example embodiment includes a performance indicator receiving unit 111, an optimization target receiving unit 112, a classification-based proposed action specifying unit 113, a personal data receiving unit 114, a personal data analysis unit 115, an individual classification unit 116, an individual proposed action specifying unit 117, and an output unit 118. The optimization proposal apparatus 110 according to the second example embodiment is different from the optimization proposal apparatus 100 according to the first example embodiment in that the optimization proposal apparatus 110 according to the second example embodiment includes the performance indicator receiving unit 111 and the classification-based proposed action specifying unit 113. Operations and functions of the optimization target receiving unit 112, the personal data receiving unit 114, the personal data analysis unit 115, and the individual classification unit 116 are the same as those of the optimization target receiving unit 101, the personal data receiving unit 102, the personal data analysis unit 103, and the individual classification unit 104 according to the first example embodiment, and thus descriptions thereof are omitted.

The performance indicator receiving unit 111 is a unit that receives an input of a target performance indicator of a city and converts the performance indicator into an optimization target. The performance indicator and the optimization target have the same concept as that in the first example embodiment. The performance indicator receiving unit 111 automatically converts the performance indicator into the optimization target using, for example, a conversion model trained in advance. The performance indicator receiving unit 111 may specify the optimization target with reference to a table in which the performance indicator and the optimization target stored in advance in a storage device 505 are associated with each other.

The classification-based proposed action specifying unit 113 is a unit that specifies a proposed action that individuals should take for each classification in order to achieve the optimization target. For example, in a case where the optimization target is a medical cost reduction of 20%, the medical cost is reduced for each classification, that is, an opportunity for an individual to use a medical service is reduced, and an action to be taken to be healthy is specified. For example, when a proposed action to be taken is specified for each classification, the proposed action is proposed to walk along a route with a large load for a classification in which individuals are used to exercise, and a proposed action is proposed to walk along a route with a small load for a classification in which individuals are not used to exercise.

The individual proposed action specifying unit 117 associates the proposed actions specified by the classification-based proposed action specifying unit 113 for each classification with classifications classified by the individual classification unit 116, thereby specifying the contents of the proposed actions for the individuals. The individual proposed action specifying unit 117 outputs the contents of the specified proposed actions to the output unit 118.

The output unit 118 has a function of prompting individuals to take proposed action proposed by the individual proposed action specifying unit 117, in addition to the function of the output unit 106 in the first example embodiment. The output unit 118 notifies the target persons who will take the proposed actions to take the proposed actions by a display screen or a message of the application. Each individual who is notified of the content of the proposed action can select whether to accept the notified proposed action. When the proposed action is not accepted by the target person, the output unit 118 outputs the information to the individual proposed action specifying unit 117. Next, the individual proposed action specifying unit 117 specifies another proposed action, and the output unit 118 notifies the target person of the another proposed action. When the individual accepts the content of the proposed action and the target person takes the action, the output unit 118 may transmit a screen indicating praise to a terminal held by the target person.

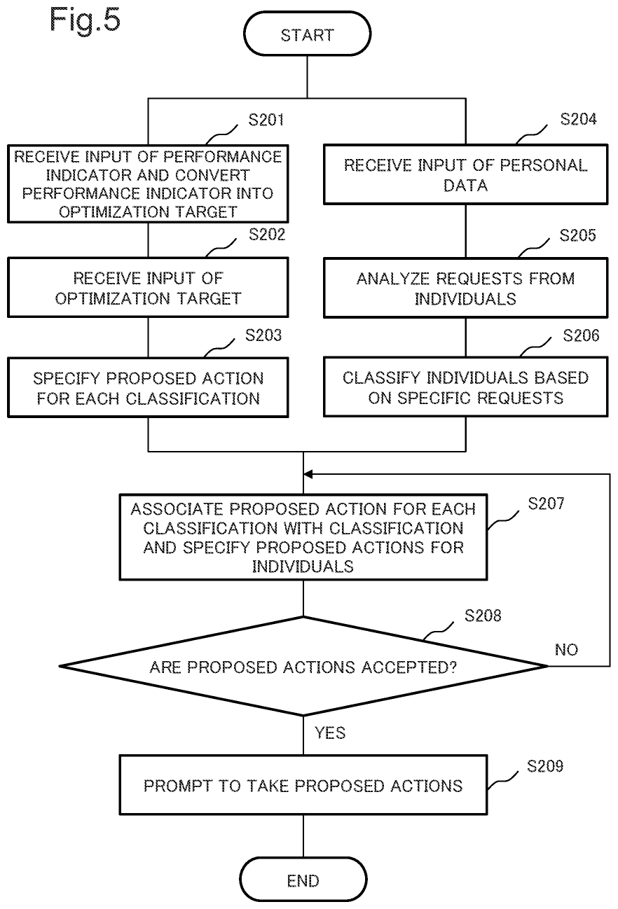

The operation of the optimization proposal apparatus 110 configured as described above will be described with reference to a flowchart of FIG. 5.

FIG. 5 is a flowchart illustrating the operation of the optimization proposal apparatus 110 according to the second example embodiment. A process according to this flowchart may be executed based on program control by the processor described above.

As illustrated in FIG. 5, first, the performance indicator receiving unit 111 receives an input of a performance indicator and converts the performance indicator into an optimization target (step S201). Next, the optimization target receiving unit 112 receives an input of the optimization target from the performance indicator receiving unit 111 (step S202). The classification-based proposed action specifying unit 113 specifies a proposed action for each classification for achievement of the optimization target (step S203). Next, the personal data receiving unit 114 receives an input of personal data regarding individuals (step S204). Next, the personal data analysis unit 115 analyzes requests from the individuals based on the personal data (step S205). Next, the individual classification unit 116 classifies the individuals who hold the requests analyzed by the personal data analysis unit 115 (step S206). Next, the individual proposed action specifying unit 117 specifies a proposed action by associating the proposed action specified by the classification-based proposed action specifying unit 113 for each classification with the classification classified by the individual classification unit 116 (step S207). The output unit 118 notifies the target persons of the proposed actions, and the target persons inputs information indicating whether to accept the proposed actions (step S208). When the target persons accept the proposed actions (step S208: YES), the output unit 118 prompts the target individuals to take the proposed actions (step S209). When the target persons do not accept the proposed actions (step S208: NO), the process returns to step S207, and the individual proposed action specifying unit 117 specifies another proposed action. Thus, the optimization proposal apparatus 110 ends the operation of the optimization proposal.

In the present example embodiment, the output unit 118 prompts the target individuals to take the proposed actions proposed by the individual proposed action specifying unit 117, thereby promoting achievement of the requests from the individuals.

### Modification of Second Example Embodiment

A modification of the second example embodiment will be described. An outsourced party selecting unit 119 that selects an outsourced party of a business that prompts an individual to take a proposed action specified by the individual proposed action specifying unit 117 of the second example embodiment is provided. In the modification of the second example embodiment, for example, it is assumed that an activity of a local government is outsourced to a private company by a pay for success (PFS) or the like. That is, in the present modification, it is assumed that a private company performs an activity for achieving a target performance indicator of a city set by a local government. The outsourced party selecting unit 119 performs matching between a business outsourced by an administration and a company to which the business is outsourced.

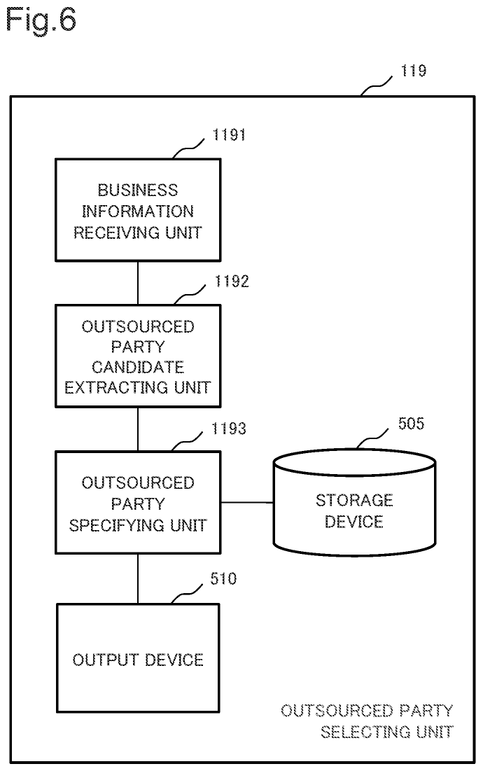

FIG. 6 is a block diagram illustrating a configuration of the outsourced party selecting unit 119 according to the modification of the second example embodiment. As illustrated in FIG. 6, the outsourced party selecting unit 119 includes a business information receiving unit 1191 that receives an input of information regarding an outsourcing business, an outsourced party candidate extracting unit 1192 that extracts an outsourced party candidate from past performance information of a business related to the outsourcing business, and an outsourced party specifying unit 1193 that specifies an outsourced party from the outsourced party candidate extracted by the outsourced party candidate extracting unit 1192.

The business information receiving unit 1191 receives an input of information regarding the outsourcing business through an input device 509. The information regarding the outsourcing business is, for example, an outsourcing business period, or a success reward amount according to a performance indicator and an achievement level of the performance indicator. The success reward amount may be set in stages depending on the achievement level of the performance indicator. For example, the success reward amount may be higher as the achievement level is higher, such as 10 million yen for a medical cost reduction of 10% and 15 million yen for a medical cost reduction of 15%.

The outsourced party candidate extracting unit 1192 extracts information of company data (outsourced party candidate) having a past record related to the performance indicator received by the business information receiving unit 1191 through the network. For example, the outsourced party candidate extracting unit 1192 may extract past performance information from administrative document management information registered in a blockchain among a plurality of administrative agencies.

The outsourced party specifying unit 1193 specifies an outsourced party based on past performance of the outsourced party candidate extracted by the outsourced party candidate extracting unit 1192 and evaluation information for the performance. The evaluation information includes, for example, an achievement level of an evaluation index, whether a problem is present at the time of past outsourcing, and the like. The outsourced party specifying unit 1193 specifies an outsourced party from among outsourced party candidates using an outsourced party analysis model generated based on the content of the past performance and the evaluation information for the performance. This model is, for example, a model that specifies and outputs an optimum outsourced business operator from among the outsourced party candidates when information of the outsourced party candidates extracted by the outsourced party candidate extracting unit 1192 is input. This model is, for example, a model generated by a decision tree, a neural network, a regression model, a deep learning neural network, or the like, and is stored in the storage device 505. In the present example embodiment, a model that outputs an optimum outsourced party when information regarding the outsourcing business is input may be used. In this case, a series of operations including the reception of input of information regarding the outsourcing business by the business information receiving unit 1191, the extraction of the outsourced party candidates by the outsourced party candidate extracting unit 1192, and the specifying of the outsourced party by the outsourced party specifying unit 1193 are automatically executed. The outsourced party specifying unit 1193 outputs the information regarding the specified outsourced party by, for example, an output device 510.

In the modification of the present example embodiment, after the outsourced business ends, the automatic calculation of a success reward and the automatic payment of the success reward may be performed by a smart contract. The smart contract is a mechanism that is executed on a blockchain network and is executed to perform a specific operation when a specific condition is satisfied. In the payment of the success reward using the smart contract, the outsourced business operator inputs the result of the performance indicator by the outsourcing business on the blockchain, so that the success reward amount is automatically calculated, and the calculated success reward amount is paid to the outsourced business operator.

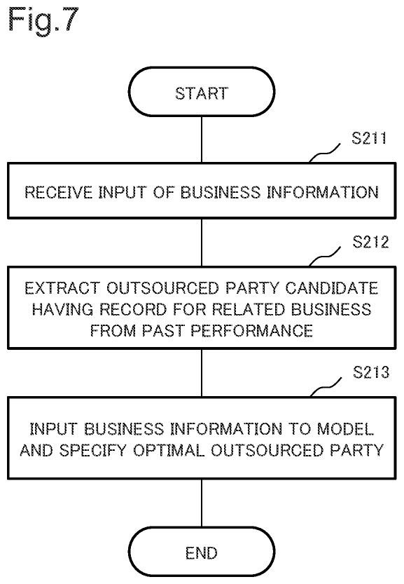

The operation of the outsourced party selecting unit 119 configured as described above will be described with reference to the flowchart of FIG. 7. First, the business information receiving unit 1191 receives an input of information regarding the outsourcing business (step S211). Next, the outsourced party candidate extracting unit 1192 extracts, as an outsourced party candidate, information of company data having a past record related to the received performance indicator (step S212). Finally, the outsourced party specifying unit 1193 inputs the extracted information of the outsourced party candidate to the model and specifies the outsourced party (step S213). As described above, the outsourced party selecting unit 119 ends the operation of the outsourced party selection.

In the modification of the present example embodiment, the outsourced party is specified using the outsourced party analysis model created based on the content of the past performance and the evaluation information for the performance. As a result, it is possible to select an optimal outsourced business operator.

Although the present invention has been described with reference to the example embodiments, the present invention is not limited to the example embodiments. Various modifications that can be understood by those skilled in the art can be made to the configuration and details of the present invention within the scope of the present invention. For example, in the present example embodiment, the optimization proposal apparatus 110 may not include the performance indicator receiving unit 111.

Although the plurality of operations are described in order in the form of the flowcharts, the order of description does not limit the order of performing the plurality of operations. Therefore, when each embodiment is implemented, the order of the plurality of operations can be changed within a range that does not affect the content.

Some or all of the above example embodiments can be described as the following supplementary notes, but are not limited to the following.

### (Supplementary Note 1)

An optimization proposal apparatus including:
an optimization target receiving means that receives an input of an optimization target for achieving a target performance indicator of a city;
a personal data receiving means that receives an input of personal data regarding a plurality of individuals belonging to the city;
a personal data analysis means that analyzes requests from the plurality of individuals based on the personal data received by the personal data receiving means;
an individual classification means that classifies the individuals based on the requests analyzed by the personal data analysis means;
an individual proposed action specifying means that specifies a proposed action for each of the individuals based on the classification by the individual classification means; and
an output means that outputs the specified proposed action for each of the individuals.

### (Supplementary Note 2)

The optimization proposal apparatus described in Supplementary Note 1, wherein the individual proposed action specifying means specifies a proposed action for each of the individuals by a trained model generated by learning the classification classified by the individual classification means and a proposed action proposed for the classification as learning data.

### (Supplementary Note 3)

The optimization proposal apparatus described in Supplementary Note 2, wherein the model updates the model based on an acceptance rate of each of the individuals for the proposed action specified by the individual proposed action specifying means.

### (Supplementary Note 4)

The optimization proposal apparatus described in Supplementary Note 1 further including a classified proposed action specifying means that specifies, for each classification, a proposed action for solving the optimization target input by the optimization target receiving means, wherein
the individual proposed action specifying means specifies a proposed action for each of the individuals by associating the proposed action specified by the classified proposed action specifying means for each classification with the classification by the individual classification means.

### (Supplementary Note 5)

The optimization proposal apparatus described in any one of Supplementary Notes 1 to 4, wherein the individual classification means classifies the individuals by a trained model generated by learning the personal data and classifications classified based on the personal data as learning data.

### (Supplementary Note 6)

The optimization proposal apparatus described in any one of Supplementary Notes 1 to 5 further including a performance indicator receiving means that receives an input of the target performance indicator of the city and converts the performance indicator into the optimization target.

### (Supplementary Note 7)

The optimization proposal apparatus described in any one of Supplementary Notes 1 to 6, wherein the output means prompts the proposed action proposed by the individual proposed action specifying means.

(Supplementary Note 8) The optimization proposal apparatus described in any one of Supplementary Notes 1 to 6 further including an outsourced party selecting means that selects an outsourced party to be prompted to take the proposed action proposed by the individual proposed action specifying means.

### (Supplementary Note 9)

The optimization proposal apparatus described in Supplementary Note 8, wherein the outsourced party selecting means includes a business information receiving means that receives an input of information regarding an outsourcing business, an outsourced party candidate extracting means that extracts an outsourced party candidate from past performance information of a business related to the outsourcing business, and an outsourced party specifying means that selects an outsourced party from among the outsourced party candidate extracted by the outsourced party candidate extracting means.

(Supplementary Note 10) The optimization proposal apparatus described in Supplementary Note 9, wherein the outsourced party candidate extracting means acquires past performance information based on administrative document management information.

### (Supplementary Note 11)

The optimization proposal apparatus described in Supplementary Note 9 or 10, wherein the outsourced party specifying means specifies the outsourced party using a model generated based on past performance and evaluation information for the performance.

### (Supplementary Note 12)

An optimization proposal method including:
receiving an input of an optimization target for achieving a target performance indicator of a city;
receiving an input of personal data regarding a plurality of individuals belonging to the city;
analyzing requests from the plurality of individuals based on the received personal data;
classifying the individuals based on the analyzed requests;
specifying a proposed action for each of the individuals based on the classification; and
outputting the specified proposed action for each of the individuals.

### (Supplementary Note 13)

A recording medium storing a program for causing a computer to execute:
receiving an input of an optimization target for achieving a target performance indicator of a city;
receiving an input of personal data regarding a plurality of individuals belonging to the city;
analyzing requests from the plurality of individuals based on the received personal data;
classifying the individuals based on the analyzed requests;
specifying a proposed action for each of the individuals based on the classification; and
outputting the specified proposed action for each of the individuals.

### REFERENCE SIGNS LIST

100, 110 optimization proposal apparatus
101, 112 optimization target receiving unit
102, 114 personal data receiving unit
103, 115 personal data analysis unit
104, 116 individual classification unit
105, 117 individual proposed action specifying unit
106, 118 output unit
111 performance indicator receiving unit
113 classification-based proposed action specifying unit
119 outsourced party selecting unit

What is claimed is:

1. An optimization proposal apparatus comprising:
a memory storing instructions; and
at least one processor configured to execute the instructions to:
receive an input of an optimization target for achieving a target performance indicator of a city;
receive an input of personal data regarding a plurality of individuals belonging to the city;
a personal data analysis means configured to analyze requests from the plurality of individuals based on the personal data received by the personal data receiving means;
classify the individuals based on the requests analyzed by the personal data analysis means;
specify a proposed action for each of the individuals based on the classification; and
output the specified proposed action for each of the individuals.

2. The optimization proposal apparatus according to claim 1, wherein the at least one processor is further configured to execute the instructions to:
specify a proposed action for each of the individuals by a trained model generated by learning the classification classified and a proposed action proposed for the classification as learning data.

3. The optimization proposal apparatus according to claim 2, wherein the at least one processor is further configured to execute the instructions to:
update the model based on an acceptance rate of each of the individuals for the proposed action specified.

4. The optimization proposal apparatus according to claim 1, wherein the at least one processor is further configured to execute the instructions to:
specify, for each classification, a proposed action for solving the optimization target input; and
specify a proposed action for each of the individuals by associating the proposed action specified for each classification with the classification.

5. The optimization proposal apparatus according to claim 1, wherein the at least one processor is further configured to execute the instructions to:
classify the individuals by a trained model generated by learning the personal data and classifications classified based on the personal data as learning data.

6. The optimization proposal apparatus according to claim 1, wherein the at least one processor is further configured to execute the instructions to:
receive an input of the target performance indicator of the city; and
convert the performance indicator into the optimization target.

7. The optimization proposal apparatus according to claim 1, wherein the at least one processor is further configured to execute the instructions to:
prompt the proposed action proposed.

8. The optimization proposal apparatus according to claim 1, wherein the at least one processor is further configured to execute the instructions to:
select an outsourced party to be prompted to take the proposed action proposed.

9. The optimization proposal apparatus according to claim 8, wherein the at least one processor is further configured to execute the instructions to:
receive an input of information regarding an outsourcing business,
extract an outsourced party candidate from past performance information of a business related to the outsourcing busines; and
select an outsourced party from among the outsourced party candidate extracted.

10. The optimization proposal apparatus according to claim 9, wherein the at least one processor is further configured to execute the instructions to:
acquire past performance information based on administrative document management information.

11. The optimization proposal apparatus according to claim 9, wherein the at least one processor is further configured to execute the instructions to:
specify the outsourced party using a model generated based on past performance and evaluation information for the performance.

12. An optimization proposal method comprising:
receiving an input of an optimization target for achieving a target performance indicator of a city;
receiving an input of personal data regarding a plurality of individuals belonging to the city;
analyzing requests from the plurality of individuals based on the received personal data;
classifying the individuals based on the analyzed requests;
specifying a proposed action for each of the individuals based on the classification; and
outputting the specified proposed action for each of the individuals.

13. A non-transitory recording medium storing a program for causing a computer to execute:
receiving an input of an optimization target for achieving a target performance indicator of a city;
receiving an input of personal data regarding a plurality of individuals belonging to the city;
analyzing requests from the plurality of individuals based on the received personal data;
classifying the individuals based on the analyzed requests;
specifying a proposed action for each of the individuals based on the classification; and
outputting the specified proposed action for each of the individuals.
